(19) United States
(12) Patent Application Publication
(10) Pub. No.: US 2016/0282683 A1
(43) Pub. Date: Sep. 29, 2016

(54) LIQUID CRYSTAL DISPLAY DEVICE

(71) Applicant: SAMSUNG DISPLAY CO., LTD., Yongin-si (KR)

(72) Inventors: Injae HWANG, Suwon-si (KR); Hyunjoon KIM, Yongin-si (KR)

(21) Appl. No.: 14/969,017

(22) Filed: Dec. 15, 2015

(30) Foreign Application Priority Data
Mar. 25, 2015 (KR) 10-2015-0041614

(51) Int. Cl. G02F 1/1343; G02F 1/1333; G02F 1/1368

(52) U.S. Cl. CPC G02F 1/134309; G02F 1/1368; G02F 1/133345; G02F 2001/134354

(57) ABSTRACT

A liquid crystal display device includes a liquid crystal layer, a first substrate, a second substrate, a pixel electrode, and an insulating layer. The liquid crystal layer is between first and second substrates and includes liquid crystal molecules. The pixel electrode is on the first substrate and includes a first sub-pixel electrode including a first stem portion and a second sub-pixel electrode including a second stem portion. The insulating layer is between the first sub-pixel electrode and the second sub-pixel electrode, and the second stem portion overlaps the first stem portion.

### CROSS-REFERENCE TO RELATED APPLICATION

Korean Patent Application No. 10-2015-0041614, filed on Mar. 25, 2015, and entitled, “Liquid Crystal Display Device,” is incorporated by reference herein in its entirety.

### BACKGROUND

1. Field

One or more embodiments herein relate to a liquid crystal display device.

2. Description of the Related Art

A liquid crystal display (LCD) is a type of flat panel display which has gained wide acceptance. An LCD includes liquid crystal layer between two substrates having electrodes. In operation, liquid crystal molecules in the liquid crystal layer are arranged based on voltages applied by the electrodes. The arrangement of liquid crystal molecules controls the amount of light transmitted from a backlight to form an image.

Various types of LCDs have been developed. Examples include twisted nematic mode displays, vertically aligned mode displays, fringe field switching mode displays, and an in-plane switching mode displays. These displays may differ, for example, based on the arrangement state of liquid crystal molecules and the arrangement state of electrodes in the absence of an applied electric field.

One type of display known as a homeotropic LCD achieves a wide viewing angle through, for example, the formation of a cut-out portion in a pixel electrode or the formation of a projection on a pixel electrode. In such an LCD, the tilt direction of liquid crystal molecules towards the cut-out portion or projection may be determined subsequent to the division of a single pixel into a plurality of domains. The reference viewing angle may be increased by dispersing the tilt direction of the liquid crystal molecules into several directions using the cut-out portion or projection.

In an LCD device using a domain division scheme, the domains are grouped into groups that receive different data voltages. For example, a single pixel may be divided into two or more domain groups, with different data voltages applied through coupling of a coupling electrode between the domain groups. However, the coupling electrode is made from an opaque metal formed simultaneously with a data line. This may cause a reduction in aperture ratio and light transmittance.

### SUMMARY

In accordance with one embodiment, a liquid crystal display device includes a first substrate; a second substrate opposing the first substrate; a liquid crystal layer between the first and second substrates and including liquid crystal molecules; a pixel electrode on the first substrate and including a first sub-pixel electrode including a first stem portion and a second sub-pixel electrode including a second stem portion; and an insulating layer between the first sub-pixel electrode and the second sub-pixel electrode, wherein the second stem portion overlaps the first stem portion.

The second sub-pixel electrode may be separated from the first sub-pixel electrode. The display device may include a thin film transistor on the first substrate and connected to the first sub-pixel electrode. The first and second stem portions may be arranged to form a coupling capacitor. The second sub-pixel electrode may be capacitively coupled to the first sub-pixel electrode.

The first sub-pixel electrode may include a first branch portion extending from the first stem portion in first, second, third, and fourth directions. The first branch portion may not overlap the second sub-pixel electrode. The second sub-pixel electrode may include a peripheral portion connecting end portions of the second stem portion to one another and includes four edges. The second sub-pixel electrode may include a second branch portion extending from the peripheral portion. The second branch portion may not overlap the first branch portion. The second branch portion may not overlap the first stem portion. A portion of the second branch portion may be connected to the second stem portion.

The second sub-pixel electrode may have an aperture with a shape that substantially corresponds to a shape of the first branch portion. The first sub-pixel electrode may have a plurality of sub-regions in which the first branch portion extends in the first, second, third, and fourth directions. The second sub-pixel electrode may have a plurality of sub-regions disposed outwardly from the sub-regions of the first sub-pixel electrode.

The display device may include a common electrode on the second substrate, wherein a voltage difference between the first sub-pixel electrode and the common electrode is different from a voltage difference between the second sub-pixel electrode and the common electrode. The voltage difference between the first sub-pixel electrode and the common electrode may be greater than the voltage difference between the second sub-pixel electrode and the common electrode.

The first sub-pixel electrode may be below the insulating layer, and the second sub-pixel electrode may be on the insulating layer. The display device may include a storage electrode line on the first substrate. A portion of the first sub-pixel electrode and a portion of the second sub-pixel electrode may overlap the storage electrode line.

### BRIEF DESCRIPTION OF THE DRAWINGS

Features will become apparent to those of skill in the art by describing in detail exemplary embodiments with reference to the attached drawings in which:

FIG. 1 illustrates an embodiment of an LCD device;

FIG. 2 illustrates a view along section line I-I′ in FIG. 1;

FIG. 3 illustrates a view along section line II-II′ in FIG. 1;

FIG. 4 illustrates an embodiment of a first sub-pixel electrode;

FIG. 5 illustrates an embodiment of a second sub-pixel electrode;

FIG. 6 illustrates an embodiment of a pixel; and

FIG. 7 illustrates another embodiment of an LCD device.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments.

It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

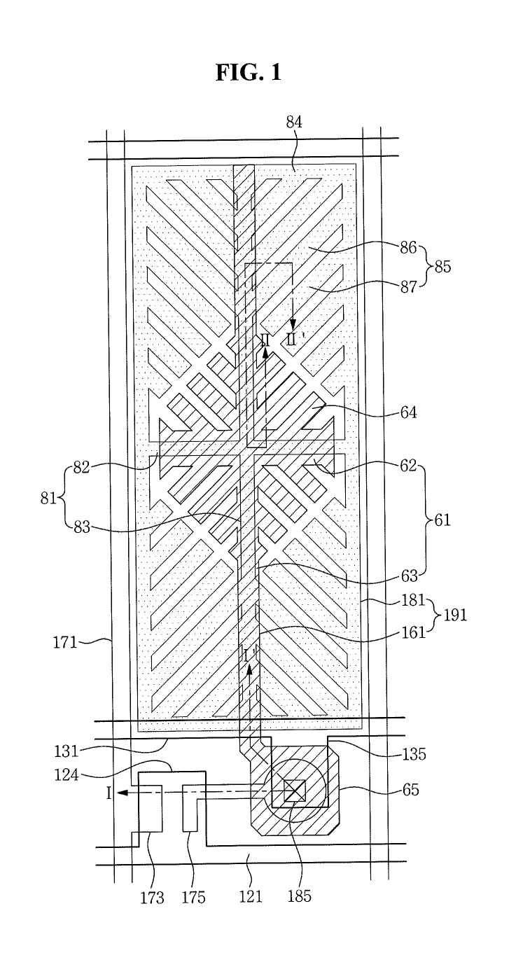

FIGS. 1 to 6 illustrate an embodiment of an LCD device which includes a liquid crystal layer 30 between a lower display panel 100 and an upper display panel 200. The upper display panel 200 includes a light shielding member 220 and a color filter 230 formed on a second substrate 210. The second substrate may include a transparent material, e.g., glass or plastic. The light shielding member 220 may be considered to be a black matrix which prevents light leakage between pixels. The color filter 230 displays one of a plurality of primary colors, for example, the three primary colors of red, green, and blue. In another embodiment, at least one of the light shielding member 220 or the color filter 230 may be disposed on the lower display panel 100.

The upper display panel 200 also includes an overcoat layer 250 and a common electrode 270. The overcoat layer 250 is on the color filter 230 and the light shielding member 220. The common electrode 270 is on the overcoat layer 250 which is formed on the second substrate 210. The common electrode 270 may be a surface-type electrode formed, for example, as a single plate that extends over the entire surface of the second substrate 210.

The liquid crystal layer 30 includes liquid crystal molecules 31 having dielectric anisotropy, e.g., positive dielectric anisotropy. Each liquid crystal molecule 31 has a major axis vertically aligned with respect to the lower and upper display panels 100 and 200 in the absence of an applied electric field in the liquid crystal layer 30. The liquid crystal molecules 31 may be nematic liquid crystal molecules having a structure in which the direction of the major axis is twisted into a spiral shape from the lower display panel 100 to the upper display panel 200.

An alignment layer may be coated on an inner surface of at least one of the lower or upper display panels 100 and 200. The alignment layer may be, for example, a homeotropic alignment layer. The alignment layer may be rubbed or photo-aligned in a predetermined direction. Accordingly, in one embodiment, the liquid crystal molecules 31 in the liquid crystal layer 30 may be initially aligned in a direction perpendicular to the lower and upper display panels 100 and 200.

The lower display panel 100 may correspond to a thin film transistor display panel. A gate conductor including a plurality of gate lines 121 may be formed on a first substrate 110 made of a transparent material such as glass or plastic. The gate lines 121 are formed on the first substrate 110 and extend primarily in a first direction (e.g., transverse direction) for transmitting gate signals. Each of the gate lines 121 may include a plurality of gate electrodes 124.

A storage electrode line 131 may extend in the transverse direction along with the gate line 121, and may include a storage electrode 135 extending therefrom. The storage electrode 135 may extend in a longitudinal direction and may be disposed in an edge portion of a pixel.

The gate line 121 and the storage electrode line 131 may be formed of a metal such as aluminum (Al), an Al alloy, silver (Ag), a Ag alloy, copper (Cu), a Cu alloy, molybdenum (Mo), a Mo alloy, chromium (Cr), titanium (Ti), or tantalum (Ta). The gate line 121 and the storage electrode line 131 may have a monolayer structure or a multilayer structure including a metal layer of, for example, Cr, Mo, Ti, Ta, having excellent physicochemical properties, and a metal layer of Al-based or Ag-based metal or Cu having a relatively low resistivity. By way of example, the multilayer may include a Mo (or a Mo alloy)/Al (or Al alloy) layer.

A gate insulating layer 140 may be on the gate line 121 and may be formed of an inorganic insulating material such as silicon nitride (SiNₓ) or silicon oxide (SiOₓ).

A semiconductor 154 may be on the gate insulating layer 140 and may include, for example, amorphous silicon, polycrystalline silicon, or an oxide semiconductor. The oxide semiconductor may include one or more predetermined materials including but not limited to zinc (Zn), gallium (Ga), indium (In), and tin (Sn). The oxide semiconductor may be an oxide semiconductor material, for example, Zn, Ga, Sn, or In based oxide, or a composite oxide such as zinc oxide (ZnO), indium-gallium-zinc oxide (InGaZnO₄), indium-zinc oxide (In—Zn—O), or zinc-tin oxide (Zn—Sn—O).

The oxide semiconductor may include, for example, IGZO-based oxide including In, Ga, Zn, and oxygen (O). The oxide semiconductor may include In—Sn—Zn—O based metal oxide, In—Al—Zn—O based metal oxide, Sn—Ga—Zn—O based metal oxide, Al—Ga—Zn—O based metal oxide, Sn—Al—Zn—O based metal oxide, In—Zn—O based metal oxide, Sn—Zn—O based metal oxide, Al—Zn—O based metal oxide, In—O based metal oxide, Sn—O based metal oxide, and Zn—O based metal oxide.

Ohmic contact members 163 and 165 may be on the semiconductor 154 and may include, for example, silicide or n+hydrogenated amorphous silicon doped with n-type impurities at high concentration such as phosphorus. The ohmic contact members 163 and 165 may be disposed on the semiconductor 154 in pairs. If the semiconductor 154 is an oxide semiconductor, the ohmic contact members 163 and 165 may be omitted.

A data conductor including a data line 171, which includes a source electrode 173 and drain electrode 175, may be formed on the ohmic contact members 163 and 165 and the gate insulating layer 140. The data line 171 transmits a data signal, and may be on the first substrate 110 and may extend in a second direction (e.g., longitudinal direction) intersecting the gate line 121.

The gate electrode 124, the source electrode 173, and the drain electrode 175 form a single thin film transistor (TFT) Q, along with the semiconductor 154. In operation, a channel of the TFT Q is formed in the semiconductor 154 between the source electrode 173 and the drain electrode 175.

An insulating layer 180 may insulate different components. The insulating layer 180 includes a first insulating layer 180a, a second insulating layer 180b, and a third insulating layer 180c. The first insulating layer 180a is on the data conductor, the gate insulating layer 140, and an exposed portion of the semiconductor 154. The first insulating layer 180a may be formed of at least one of the following materials: an inorganic insulating material such as SiNₓ or SiOₓ, an organic insulating material, or a low dielectric constant insulating material.

The second insulating layer 180b is on the first insulating layer 180a and may be formed of an organic insulating material with a planarized surface. The second insulating layer 180b may have a thickness that varies based on a position. In other words, the second insulating layer 180b may serve as a planarization layer.

The second insulating layer 180b may include a color filter for emitting light of one of a plurality of primary colors. Examples of the primary colors include, for example, the colors of red, green, and blue or the colors of yellow, cyan, magenta.

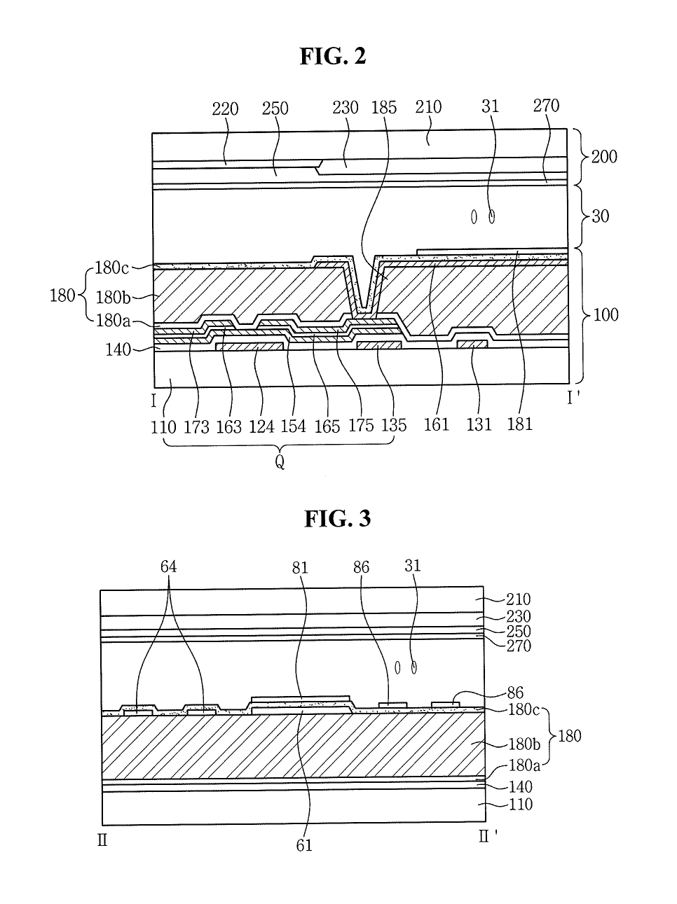

As illustrated in FIGS. 1 and 2, a pixel electrode 191 includes a first sub-pixel electrode 161 separated from a second sub-pixel electrode 181. The pixel electrode 191 may be formed of a transparent conductive material such as indium-tin oxide (ITO) or indium-zinc oxide (IZO).

The third insulating layer 180c is between the first sub-pixel electrode 161 and the second sub-pixel electrode 181. The first sub-pixel electrode 161 may be below the third insulating layer 180c and the second sub-pixel electrode 181 may be on the third insulating layer 180c. Alternatively, the first sub-pixel electrode 161 may be on the third insulating layer 180c and the second sub-pixel electrode 181 may be below the third insulating layer 180c.

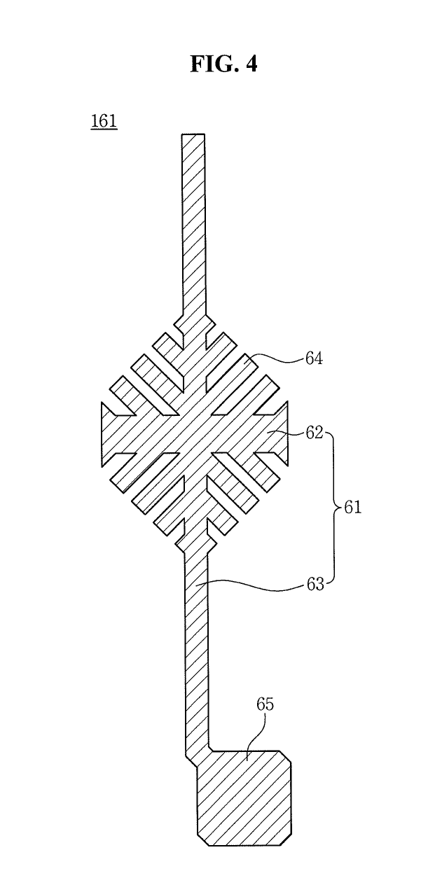

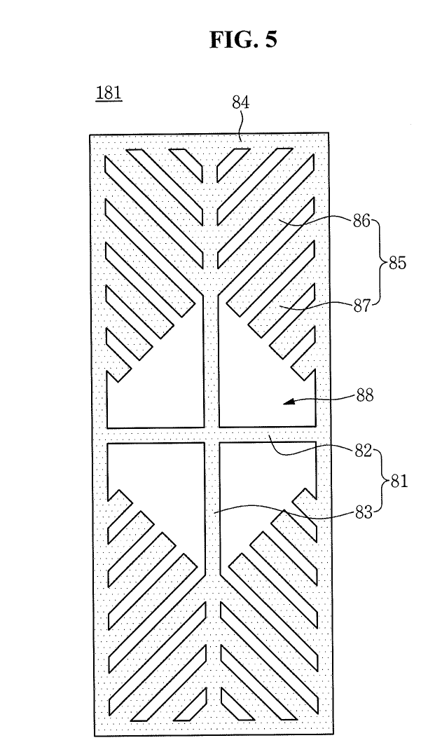

Referring to FIG. 4, the first sub-pixel electrode 161 may be on the second insulating layer 180b and may include a first stem portion 61 including a first transverse stem portion 62 and a first longitudinal stem portion 63, a first branch portion 64, and a protrusion portion 65. The first stem portion 61, the first branch portion 64, and the protrusion portion 65 may be integrally formed.

The first sub-pixel electrode 161 may have a predetermined (e.g., a polygonal) shape such as a hexagon. The first sub-pixel 161 may include the first longitudinal stem portion 63 and the first transverse stem portion 62, which are formed in a central portion of the first sub-pixel electrode 161 and which are connected to one another. The first branch portion 64 extends from the first transverse stem portion 62 and the first longitudinal stem portion 63. The first stem portion 61 may have, for example, a cross shape and may overlap a second stem portion 81 of the second sub-pixel electrode 181.

The first branch portion 64 extends from the first stem portion 61 in upper right, lower right, upper left, and lower left directions. The first branch portion 64 may not overlap the second sub-pixel electrode 181. The first branch portion 64 may form an angle in a range of, for example, about 45 to about 135 degrees relative to the gate line 121 or the first transverse stem portion 62. In addition, first branch portions 64 in two adjacent sub-regions of the first sub-pixel electrode 161 may intersect one another. The width of the first branch portion 64 and an interval between two adjacent first branch portions 64 may be, for example, in a range of about 1 micrometer (μm) to about 10 μm.

The first sub-pixel electrode 161 may be divided into a plurality of sub-regions based on the direction in which the first branch portion 64 extends, with the first stem portion 61 serving as a boundary therebetween. The first sub-pixel electrode 161 may have the plurality of sub-regions in which the first branch portion 64 extends in the upper right, lower right, upper left, and lower left directions. For example, the first sub-pixel electrode 161 of the LCD device may be divided into four sub-regions. The first branch portion 64 may extend in the four sub-regions in four different directions.

The third insulating layer 180c may be on the first sub-pixel electrode 161, may be formed of an organic insulating material, and may insulate the first sub-pixel electrode 161 from the second sub-pixel electrode 181. The second sub-pixel electrode 181 may be on the third insulating layer 180c and may include a second stem portion 81 which includes a second transverse stem portion 82 and a second longitudinal stem portion 83, a second branch portion 85, and a peripheral portion 84.

Referring to FIG. 5, the second sub-pixel electrode 181 may surround the first sub-pixel electrode 161. The second longitudinal stem portion 83 and the second transverse stem portion 82 may be connected to one another. The second stem portion 81 of the second sub-pixel electrode 181 may overlap the first stem portion 61 of the first sub-pixel electrode 161.

The second branch portion 85 may extend from the peripheral portion 84. For example, the second branch portion 85 may, as illustrated in FIG. 5, extend from the peripheral portion 84 in the upper right, lower right, upper left, and lower left directions. The second branch portion 85 may form an angle in a range of, for example, about 45 to about 135 relative to the gate line 121 or the second transverse stem portion 82. In addition, second branch portions 85 in two adjacent sub-regions of the second sub-pixel electrode 181 may intersect one another.

The second branch portion 85 of the second sub-pixel electrode 181 may be spaced apart from the first branch portion 64 of the first sub-pixel electrode 161 at a predetermined interval. As illustrated in FIGS. 1 and 5, a portion of the second branch portion 85 may be connected to the second stem portion 81. For example, a first portion 86 of the second branch portion 85 may extend from the peripheral portion 84 to be connected to the second longitudinal stem portion 83. A second portion 87 of the second branch portion 85 may extend from the peripheral portion 84 and may not be connected to the second longitudinal stem portion 83. In other words, the second branch portion 85 may be formed so as not to overlap the first branch portion 64. In addition, the second branch portion 85 may not overlap the first stem portion 61. In order for the second branch portion 85 to not overlap the first sub-pixel electrode 161, the second sub-pixel electrode 181 may have an aperture 88 having a shape corresponding to a shape of the first branch portion 84.

The peripheral portion 84 may connect end portions of the second stem portion 81 to one another and may include a plurality (e.g., four) edges. As previously described, the peripheral portion 84 may be connected to the second longitudinal stem portion 83 through the first portion 86 of the second branch portion 85.

The second sub-pixel electrode 181 may have a plurality of sub-regions disposed outwardly from the sub-regions of the first sub-pixel electrode 161. For example, the second sub-pixel electrode 181 may include a plurality of sub-regions in four sides of the first sub-pixel electrode 161, which may have, for example, a polygonal shape. The sub-regions of the second sub-pixel electrode 181 may be divided by a space between the first branch portion 64 and the second branch portion 85, and by the peripheral portion 84. For example, the second sub-pixel electrode 181 of the LCD device may be divided into four sub-regions.

A portion of the first sub-pixel electrode 161 and a portion of the second sub-pixel electrode 181 may overlap the storage electrode line 131 to form a storage capacitor. The upper display panel 200 and the lower display panel 100 having a structure as described above may be aligned to be coupled to one another. Liquid crystal material may be injected therebetween to be vertically aligned.

Hereinafter, an example of voltages applied to the first sub-pixel electrode 161 and the second sub-pixel electrode 181 and a coupling capacitor formed by the first sub-pixel electrode 161 and the second sub-pixel electrode 181 will be discussed.

The first sub-pixel electrode 161 is connected to the TFT Q through the drain electrode 175. As a result, the first sub-pixel electrode 161 receives an applied image signal voltage transmitted through the TFT Q and the data line 171. On the other hand, since a voltage of the second sub-pixel electrode 181 varies due to a capacitive coupling based on overlap between the second first and sub-pixel electrodes 161 and 181, the voltage of the second sub-pixel electrode 181 may have an absolute level invariably lower than the voltage of the first sub-pixel electrode 161. In this regard, two sub-pixel electrodes (e.g., first and second sub-pixel electrodes 161 and 181) which have different voltages may be disposed in a single pixel region, so that different gamma curves may be obtained. These different gamma curves may compensate with one another in order to reduce distortion, thereby achieving excellent visibility.

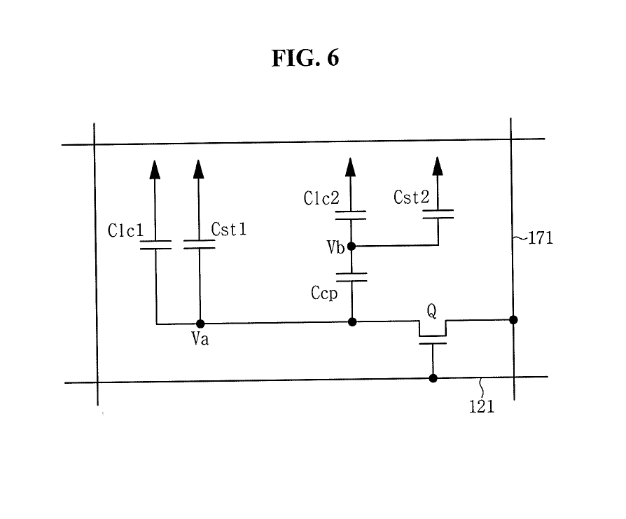

FIG. 6 provides an indication of one reason that the voltage of the first sub-pixel electrode 161 is maintained to be lower than the voltage of the second sub-pixel electrode 181. In FIG. 6, Clc1 is a liquid crystal capacitor between the first sub-pixel electrode 161 and the common electrode 270, Cst1 is a storage capacitor between the first sub-pixel electrode 161 and the storage electrode line 131, Clc2 is a liquid crystal capacitor between the second sub-pixel electrode 181 and the common electrode 270, Cst2 is a storage capacitor between the second sub-pixel electrode 181 and the storage electrode line 131, and Ccp is a coupling capacitor between the second sub-pixel electrode 181 and the first sub-pixel electrode 161.

The voltage of the first sub-pixel electrode 161 with respect to the voltage of the common electrode 270 is denoted by Va. The voltage of the second sub-pixel electrode 181 is denoted by Vb. Thus, Vb=Va×[Ccp/(Ccp+Clc1)], based on the voltage divider rule. Since the value calculated by Ccp/(Ccp+Clc2) is invariably less than 1, Vb may be invariably lower than Va.

The ratio of Vb to Va may be adjusted by adjusting the coupling capacitor Ccp.

Adjustment of the coupling capacitor Ccp may be performed, for example, by adjusting the overlapping area and a distance between the first stem portion 61 of the first sub-pixel electrode 161 and the second stem portion 81 of the second sub-pixel electrode 181. In one embodiment, the overlapping area may be readily adjusted by varying the width of the second stem portion 81 of the second sub-pixel electrode 181, and the distance may be adjusted by varying a thickness of the third insulating layer 180c or a position of the second stem portion 81. In this instance, Vb may be higher than Va, e.g., by about 0.6 to about 0.8 times.

The third insulating layer 180c is between the first stem portion 61 and the second stem portion 81, which overlap one another. Thus, the first and second stem portions 61 and 81 may form the coupling capacitor Ccp. For example, the coupling capacitor Ccp is formed using the transparent second sub-pixel electrode 181 without forming an additional opaque coupling electrode. As a result, aperture ratio may be enhanced, and accordingly side visibility of the LCD device may be improved.

As previously described, since the second sub-pixel electrode 181 receives a voltage applied thereto having a level lower than that of the first sub-pixel electrode 161, the voltage difference between the first sub-pixel electrode 161 and the common electrode 270 may differ from a voltage difference between the second sub-pixel electrode 181 and the common electrode 270. For example, the voltage difference between the first sub-pixel electrode 161 and the common electrode 270 may be greater than the voltage difference between the second sub-pixel electrode 181 and the common electrode 270.

The first sub-pixel electrode 161 and the second sub-pixel electrode 181 receive different applied voltages to generate electric fields, along with the common electrode 270 of the upper display panel 200. The electric fields control the directions of the liquid crystal molecules 31 in the liquid crystal layer 30 between the pixel electrode 191 and the common electrode 270. The luminance of light transmitting through the liquid crystal layer 30 varies based on the direction of the liquid crystal molecules 31.

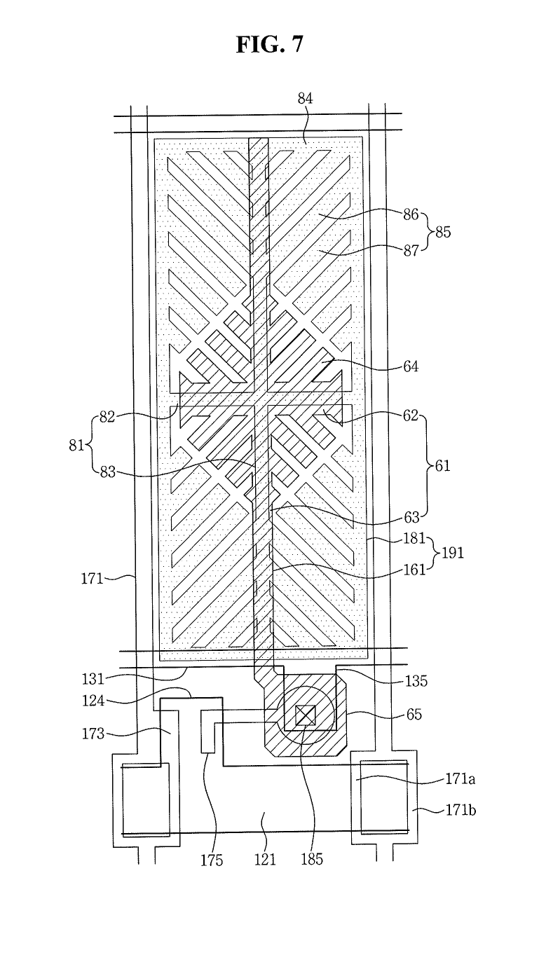

FIG. 7 illustrates another embodiment of an LCD device which has substantially the same configuration as the previous embodiment, except for the shape of a portion of the data line 171. Referring to FIG. 7, the data line 171 has a first connection portion 171a and a second connection portion 171b at a position where the data line 171 overlaps a gate line 121. When the data line 171 suffers a short-circuit defect with the gate line 121, one of the first connection portion 171a or the second connection portion 171b may be cut through laser cutting. Thus, the short-circuit defect may be removed.

By way of summation and review, an LCD device a pixel may be divided into two or more domain groups, with different data voltages applied through coupling of a coupling electrode between the domain groups. However, the coupling electrode is made from an opaque metal formed simultaneously with a data line. This may cause a reduction in aperture ratio and light transmittance.

In accordance with one or more of the aforementioned embodiments, an LCD device may achieve excellent side visibility as a result of a capacitive coupling between first and second sub-pixel electrodes. Also, the aperture ratio may be improved because the coupling electrode may be omitted. Also, the second sub-pixel electrode may directly overlap the first sub-pixel electrode to allow high resolution to be achieved.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A liquid crystal display device, comprising:
a first substrate;
a second substrate opposing the first substrate;
a liquid crystal layer between the first and second substrates and including liquid crystal molecules;
a pixel electrode on the first substrate, the pixel electrode including a first sub-pixel electrode having a first stem portion and a second sub-pixel electrode having a second stem portion; and
an insulating layer between the first sub-pixel electrode and the second sub-pixel electrode, wherein the second stem portion overlaps the first stem portion.

2. The device as claimed in claim 1, wherein the second sub-pixel electrode is separated from the first sub-pixel electrode.

3. The device as claimed in claim 2, further comprising:
a thin film transistor on the first substrate and connected to the first sub-pixel electrode.

4. The device as claimed in claim 3, wherein the first and second stem portions are arranged to form a coupling capacitor.

5. The device as claimed in claim 4, wherein the second sub-pixel electrode is capacitively coupled to the first sub-pixel electrode.

6. The device as claimed in claim 1, wherein the first sub-pixel electrode includes a first branch portion extending from the first stem portion in first, second, third, and fourth directions.

7. The device as claimed in claim 6, wherein the first branch portion does not overlap the second sub-pixel electrode.

8. The device as claimed in claim 6, wherein the second sub-pixel electrode includes a peripheral portion connecting end portions of the second stem portion to one another and includes four edges.

9. The device as claimed in claim 8, wherein the second sub-pixel electrode includes a second branch portion extending from the peripheral portion.

10. The device as claimed in claim 9, wherein the second branch portion does not overlap the first branch portion.

11. The device as claimed in claim 10, wherein the second branch portion does not overlap the first stem portion.

12. The device as claimed in claim 11, wherein a portion of the second branch portion is connected to the second stem portion.

13. The device as claimed in claim 6, wherein the second sub-pixel electrode has an aperture with a shape that substantially corresponds to a shape of the first branch portion.

14. The device as claimed in claim 6, wherein the first sub-pixel electrode has a plurality of sub-regions in which the first branch portion extends in the first, second, third, and fourth directions.

15. The device as claimed in claim 14, wherein the second sub-pixel electrode has a plurality of sub-regions disposed outwardly from the sub-regions of the first sub-pixel electrode.

16. The device as claimed in claim 1, further comprising:
a common electrode on the second substrate,
wherein a voltage difference between the first sub-pixel electrode and the common electrode is different from a voltage difference between the second sub-pixel electrode and the common electrode.

17. The device as claimed in claim 16, wherein the voltage difference between the first sub-pixel electrode and the common electrode is greater than the voltage difference between the second sub-pixel electrode and the common electrode.

18. The device as claimed in claim 1, wherein:
the first sub-pixel electrode is below the insulating layer, and
the second sub-pixel electrode is on the insulating layer.

19. The device as claimed in claim 1, further comprising:
a storage electrode line on the first substrate.

20. The device as claimed in claim 19, wherein a portion of the first sub-pixel electrode and a portion of the second sub-pixel electrode overlap the storage electrode line.
